(19) United States
(12) Patent Application Publication
(10) Pub. No.: US 2015/0299945 A1
(43) Pub. Date: Oct. 22, 2015

(54) POLYURETHANE DISPERSION BASED SYNTHETIC LEATHERS COMPRISING ACRYLIC LATEX

(71) Applicant: DOW GLOBAL TECHNOLOGIES LLC, Midland, MI (US)

(72) Inventors: Weichao Gu, Shanghai (CN); Ning Kang, Qingdao (CN); Hong Liang Zhang, Shanghai (CN); Yunfei Yan, Shanghai (CN); Chao Zhang, Shanghai (CN); Bo Liu, Shanghai (CN)

(21) Appl. No.: 14/431,172

(22) PCT Filed: Oct. 16, 2012
(86) PCT No.: PCT/CN2012/083030

§ 371 Date: Mar. 25, 2015

(51) Int. Cl. D06N 3/14; C09D 133/08; D06N 3/00; C09D 133/12

(52) U.S. Cl. CPC D06N 3/144; C09D 133/12; C09D 133/08; D06N 3/0047; D06N 3/0061; D06N 3/0063; D06N 3/14; D06N 3/0077; D06N 2211/28

(57) ABSTRACT

Disclosed herein are synthetic leathers comprising latex, and having improved peel strength and/or improved embossability. The leathers comprising a fabric that is optionally impregnated with a polymer resin, wherein the fabric is in contact with a polymeric layer that was made from a mixture comprising a frothed polyurethane dispersion in water and latex. Methods of making these synthetic leathers, which have improved peel strength and/or improved embossability relative to non-latex containing synthetic leathers, are also disclosed.

### BACKGROUND OF THE INVENTION

Currently, most polyurethane (PU) synthetic leathers are made using organic solvents, such as dimethylformamide, methylethyl ketone (MEK) and toluene. These solvents vaporize during manufacture and post manufacturing, which leads to potential health issues for the manufacturing staff, the end users of the synthetic leather, and the environment. As a result, the European standard for the solvent PU based synthetic leather was changed to require less than 10 ppm DMF in the leather. Making such leathers is a challenge using organic solvent based methodologies. As a result, the use of solvent free or water borne PU (also known as polyurethane dispersion or PUD) has received attention, as it uses little, if any, organic solvent.

PUD is an aqueous emulsion of PU particles in water having high solid content, small particle size, and prolonged stability (up to six months or longer). When making synthetic leather using PUD, the following general method is used: 1) PUD is frothed 2) the frothed PUD is applied to a fabric, 3) the thickness of the frothed PUD is adjusted using methods known in the art, and 4) the now coated fabric is cured to form a synthetic leather having a poromeric layer. See U.S. Pat. No. 7,306,825 for an example of this methodology.

Synthetic leather derived from PUD is similar to that made from PU and an organic solvent. It is breathable, and has good hand-feel. More importantly, the PUD synthetic leather is low in volatile organic compounds. However, some PUD based synthetic leathers, while having acceptable hand feel, suffer from having poor peel strength, i.e., the fabric and the synthetic leather coated on it separate too easily, and/or high manufacturing costs. Furthermore, some PUD based synthetic leathers also suffer from having poor embossability. As a result, the application of PUD based synthetic leather has been limited.

It would be advantageous to develop a PUD based synthetic leather that had improved peel strength performance and reduced cost of preparation.

It would also be advantageous to develop a PUD based synthetic leather that had improved embossability characteristics and even more preferably, had improved peel strength and improved embossability.

### SUMMARY OF THE INVENTION

In one aspect, disclosed herein are synthetic leathers made from a fabric that is optionally impregnated with a polymer resin, wherein the fabric is coated with a polymerized layer that was made from a mixture comprising frothed PUD, at least one surfactant, at least one thickener and at least one latex, wherein the latex has a T_{g}≦50° C. Said leathers have improved peel strength performance and reduced cost of preparation relative to synthetic leathers that do not contain latex.

In another aspect, disclosed herein are synthetic leathers made from a fabric that is optionally impregnated with a polymer resin, wherein the fabric is coated with a polymerized layer that was made from a mixture comprising frothed PUD, at least one surfactant, at least one thickener and at least one latex, wherein the latex has a T_{g}≧50° C., the resulting synthetic leather has improved embossability characteristics and may also have improved peel strength.

In a third aspect, disclosed herein is a method of making synthetic leather, the method comprising:

frothing a mixture comprising PUD, at least one latex, at least one surfactant, and at least a thickener;

applying the frothed mixture to a short standing needled-fiber fabric that is optionally impregnated with a PU resin, thereby forming a coated fabric;

adjusting the thickness of the frothed PUD using methods known in the art; and

subjecting the coated fabric to curing conditions.

In a fourth aspect, disclosed herein is a method of increasing the peel strength (between the fabric and the PU containing layer) of a synthetic leather, the method comprising:

frothing a mixture comprising PUD, at least one latex at least one surfactant, and at least a thickener;

applying the frothed mixture to a short standing needled-fiber fabric that is optionally impregnated with a PU resin, thereby forming a coated fabric;

adjusting the thickness of the frothed PUD using methods known in the art; and

subjecting the coated fabric to curing conditions.

In a fifth aspect, disclosed herein is a method of improving the embossability of a synthetic leather, the method comprising:

frothing a mixture comprising PUD, at least one latex having a T_{g}≧50° C., at least one surfactant, and at least a thickener;

applying the frothed mixture to a short standing needled-fiber fabric that is optionally impregnated with a PU resin, thereby forming a coated fabric;
adjusting the thickness of the frothed PUD using methods known in the art; and

subjecting the coated fabric to curing conditions.

The synthetic leather and processes disclosed herein may be used to make synthetic leather for any leather or synthetic leather applications. Particular examples include footwear, handbags, belts, purses, garments, furniture upholstery, automotive upholstery, and gloves.

### DESCRIPTION OF THE FIGURES

FIG. 1 is a picture of the surface pattern of the Control Sample, post-embossment.

FIG. 2 is a picture of the surface pattern of Sample 7, post-embossment.

FIG. 3 is a picture of the surface pattern of Sample 8, post-embossment.

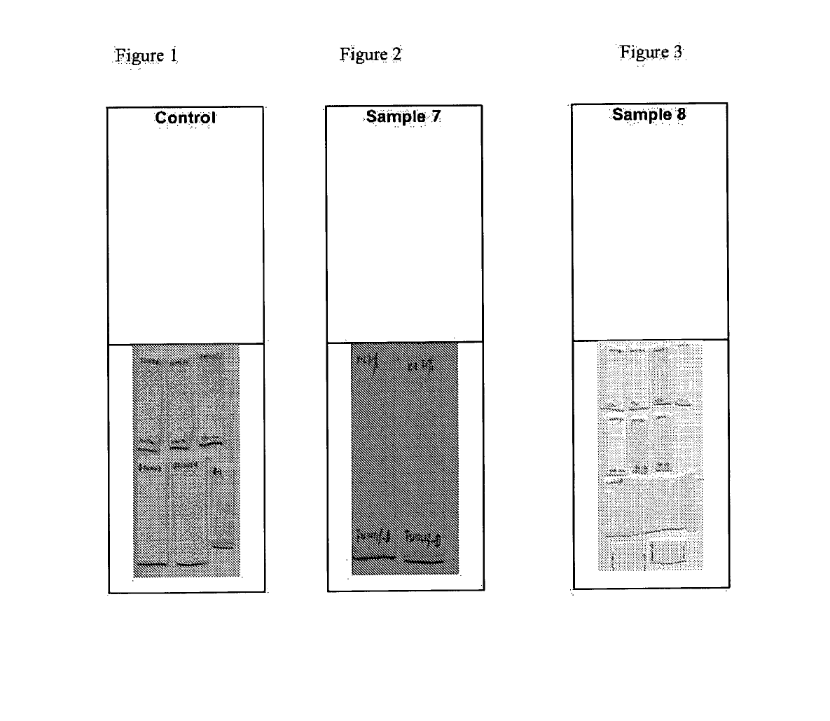

### DETAILED DESCRIPTION

As described above, disclosed herein are synthetic leathers made from mixtures comprising PUD, and methods of making synthetic leathers from PUD containing mixtures.

As previously mentioned, a polyurethane (PU) dispersed in water is referred to as a PUD. It is known in the art that PUDs are made by combining PU resin, one or more surfactants, and a solvent comprising water.

It is understood that the water that is used herein may optionally further comprise other, additional solvents, such as ketones, C₁-C₆ alcohols, ethers, polyethers, DMF, dipropylene glycol dimethyl ether, and NMP. The water may contain one or more than one additional solvent. Preferably, these additional solvents comprise less 10% by weight, based on the weight of the water and the additional solvent or solvents. More preferably they comprise less than 5% by weight. Still more preferably, it is less than 1% by weight. Most preferably, non-water solvents are not present in the PUD. And while deionized and/or distilled water may be used, it is not required. A preferred PUD is Syntegra 3000, which is an externally stabilized, high solid content MDI (methyl diphenyl diisocyanate) based waterborne polyurethane dispersion produced without the use of organic solvents that is sold by The Dow Chemical Company.

In an embodiment, the leathers and methods disclosed herein are directed towards externally stabilized, frothed PUD dispersions, which require the presence of at least one surfactant and at least one thickener in the PUD containing mixture. As known in the art, when making the frothed PUD, the PUD, surfactant(s) and thickener(s) are combined and frothed, using standard methods that are known in the art. The frothed PUD has air bubbles incorporated into it and the surfactant(s) and thickener(s) stabilize the air bubbles in the frothed mixture.

Examples of suitable surfactants include, cationic, anionic, or nonionic surfactants. Suitable classes of surfactants include, but are not restricted to, sulfates of ethoxylated phenols such as poly(oxy-1,2-ethanediyl).alpha.-sulfo-.omega.(nonylphenoxy) ammonium salt; alkali metal fatty acid salts such as alkali metal oleates and stearates; polyoxyalkylene nonionics such as polyethylene oxide, polypropylene oxide, polybutylene oxide, and copolymers thereof; alcohol alkoxylates; ethoxylated fatty acid esters and alkylphenol ethoxylates; alkali metal lauryl sulfates; amine lauryl sulfates such as triethanolamine lauryl sulfate; quaternary ammonium surfactants; alkali metal alkylbenzene sulfonates such as branched and linear sodium dodecylbenzene sulfonates; amine alkyl benzene sulfonates such as triethanolamine dodecylbenzene sulfonate; anionic and nonionic fluorocarbon surfactants such as fluorinated alkyl esters and alkali metal perfluoroalkyl sulfonates; organosilicon surfactants such as modified polydimethylsiloxanes; and alkali metal soaps of modified resins. Exemplary preferred surfactants include disodium octadecyl sulfosuccinimate, sodium dodecylbenzene sulfonate, sodium stearate and ammonium stearate.

It is preferred for one of the surfactants to be amphoteric. Preferably, the amphoteric surfactant is a betaine such as cocamidopropyl betaine. In one embodiment, at least one surfactant is ammonium stearate, disodium octadecyl sulfosuccinimate or cocamidopropyl betaine.

In some embodiments, the mixture comprises at least two surfactants, which are selected from ammonium stearate, cocamidopropyl betaine and disodium octadecyl sulfosuccinimate. In a more preferred embodiment, at least one surfactant is ammonium stearate.

In one preferred embodiment, the mixture comprises at least three surfactants. While different combinations of surfactants may be used, in at least one preferred embodiment, the at least three surfactants are selected from the group consisting of ammonium stearate, disodium octadecyl sulfosuccinimate and cocamidopropyl betaine.

The surfactant or surfactants are sometimes used as a concentrate in water. Further, the surfactant(s) may be added to the PUD or the PUD may be added to the surfactant(s).

In an embodiment according to any of the preceding aspects and/or embodiment(s), the synthetic leathers and methods described herein utilize a fabric, which is coated with the mixture comprising PUD and optionally, latex. Many different fabrics that are known in the art may be used. The fabric may be woven or nonwoven. The fabric may be made by any suitable method such as those known in the art. The fabric may be prepared from any suitable fibrous material, such as, but not limited to, synthetic fibrous materials and natural or semi synthetic fibrous materials and mixtures or blends thereof. Examples of synthetic fibrous materials include polymers, such as polyesters, polyamides, polyacrylics, polyolefins, polyvinyl chlorides, polyvinylidene chlorides, polyvinyl alcohols and blends or mixtures thereof. Examples of natural semi-synthetic fibrous materials include cotton, wool and hemp. One preferred fabric is needled cotton and polyester fiber hybrid woven fabric having short fibers (less then 1 mm) on the surface.

Another preferred fabric is needled cotton and polyester fiber hybrid woven fabric having long (greater than 3 mm) fibers on the surface.

In the leathers and methods disclosed herein, the fabric is optionally impregnated with a polymer resin. Preferred polymer resins include polyurethanes. Acceptable resins include those made from isocyanate containing resins, such as polyisocyanates, which are preferred. Examples of polyisocyanate include organic diisocyanates, and may be aromatic, aliphatic, or cycloaliphatic, or a combination thereof. Representative examples of suitable diisocyanates include 4,4′-diisocyanatodiphenylmethane, 2,4′-diisocyanatodiphenylmethane, isophorone diisocyanate, p-phenylene diisocyanate, 2,6 toluene diisocyanate, polyphenyl polymethylene polyisocyanate, 1,3-bis(isocyanatomethyl)cyclohexane, 1,4-diisocyanatocyclohexane, hexamethylene diisocyanate, 1,5-naphthalene diisocyanate, 3,3′-dimethyl-4,4′-biphenyl diisocyanate, 4,4′-diisocyanatodicyclohexylmethane, 2,4′-diisocyanatodicyclohexylmethane, and 2,4-toluene diisocyanate, or combinations thereof. More preferred diisocyanates are 4,4′-diisocyanatodicyclohexylmethane, 4,4′-diisocyanatodiphenylmethane, 2,4′-diisocyanatodi-cyclohexylmethane, and 2,4′-diisocyanatodiphenylmethane. Most preferred is 4,4′-diisocyanatodiphenylmethane (also known as 4,4′-MDI) and 2,4′-diisocyanatodiphenylmethane (also known as 2,4′-MDI). The polyisocyanates may be purified or part of a mixture of polyisocyanates.

The impregnation of the fabric may be conducted by any suitable method known in the art. Examples include dipping, spraying or doctor blading. After impregnating, the impregnated textile may have excess resin removed to leave the desired amount of dispersion within the textile. Typically, this may be accomplished by passing the impregnated textile through rubber rollers.

Generally, the impregnated fabric is impregnated with a resin in an organic solvent (which makes a solution) or water (which makes a dispersion). Typical solvents include dimethylformamide (DMF), methylethyl ketone (MEK) and toluene, although other solvents will afford acceptable results. Generally, the organic solvent used to impregnate the fabric will contain 0.5-50% by weight of resin. More preferably, the organic solvent will contain 5-30% by weight of resin. Still more preferably, 15-25% by weight of resin. The ability to prepare an impregnated fabric, using either a solution or a dispersion is well known in the art.

In embodiments according to any preceding aspects and/or embodiments, the PUD mixture contains at least one latex, wherein each latex may independently be natural or synthetic. Examples of synthetic latexes are styrene-butadiene rubber, acrylonitrile butadiene styrene, acrylic polymers, and polyvinyl acetate. Specific examples of synthetic latexes include those made from one or more of the following compounds: butyl acrylate, ethyl acrylate, 2-ethyl hexyl acrylate, glacial acrylic acid, methyl acrylate, methyl methacrylate, methyl crotonate, styrene, vinyls, butadiene, or acrylonitrile. Typically, the latex comprises 0.1-99% by weight of the pre-dried composition. More preferably, the latex comprises 1-40% by weight of the pre-dried composition. Still more preferably, the latex comprises 5-30% by weight of the pre-dried composition.

The leathers and methods of making the leathers disclosed herein, optionally further comprise an additive that is, a filler (such as wood fibers, CaCO₃, SiO₂, and TiO₂) a flame retardant, a pigment, a flowing additive, hand feel additive, antioxidant, anti-UV additive, antistatic agent, antimicrobial agent, or combinations thereof. Wood fibers also include wood flour. In one embodiment, the leathers and methods require the presence of at least one of the aforementioned additives. The aforementioned fillers, when present, account for 0.1-80% by weight of the composition (excluding the fabric). More preferably, when present, the fillers account for 0.1-50% by weight of the composition. Still more preferably, the fillers account of 0.1-30% by weight of the composition. The non-filler additives, i.e., the aforementioned additives, not including the fillers, typically account for 0.01-30% by weight of the composition. More preferably, the non-filler additives account for 0.1-20% by weight of the composition. Still more preferably, the non-filler additives account for 1-10% by weight of the composition.

Thickeners are well known in the art and any thickener may be used in the leathers and methods disclosed herein. The thickener may be non-associative or associative. It may be a cellulose ether derivative, natural gum alkali swellable emulsion, a clay, an acid derivative, an acid copolymer, a urethane associate thickener (UAT), a polyether urea polyurethane (PEUPU), a polyether polyurethane (PEPU) or a hydrophobically modified ethoxylated urethane (HEUR). One preferred thickener is based on an acrylic acid copolymer, with ethylene acrylic acid copolymer being particularly preferred. Preferably, the thickener does not cause the PUD to become unstable. In an especially preferred example, a thickener is present in the leathers and methods disclosed herein. Preferred thickeners include an acrylic acid copolymer (ACUSOL 810A, sold by The Dow Chemical Company), Methocel™ (a cellulose ether based thickener, sold by The Dow Chemical Company) and RM 825 (a polyurethane based thickener, sold by Dow Corning). Most preferred is an acrylic acid copolymer, such as ACUSOL 810A, which is sold by The Dow Chemical Company.

Examples of thickeners include those that do not cause the dispersion to become unstable. More preferably, the rheological modifier is a water soluble thickener that is not ionized. Examples of useful thickeners include methyl cellulose ethers, alkali swellable thickeners (e.g., sodium or ammonium neutralized acrylic acid polymers), hydrophobically modified alkali swellable thickeners (e.g., hydrophobically modified acrylic acid copolymers) and associative thickeners (e.g., hydrophobically modified ethylene-oxide-based urethane block copolymers). Preferably the rheological modifier is a methylcellulose ether. The amount of thickener may be any useful amount. Typically the amount of thickener is at least about 0.1% to about 10% by weight of the total weight of the dispersion. Preferably the amount of thickener is between about 0.5% to about 7% by weight. Examples of pigments, include TiO₂, carbon black and other, known pigments.

Pigments are well known in the art and typically present in less than 20% by weight, based on the dried leather.

Examples of flame retardants that may be used in the leathers and methods disclosed herein include those typically used to give enhanced flame retardant properties to a typical latex foam. Such flame retardants include phosphonate esters, phosphate esters, halogenated phosphate esters or a combination thereof. Representative examples of phosphonate esters include dimethylphosphonate (DMMP) and diethyl ethylphosphonate (DEEP). Representative examples of phosphates esters include triethyl phosphate and tricresyl phosphate. When used the phosphonate or phosphate ester flame retardants are present in the final foam at a level of from 0.5 to 30 percent by weight of the final foam.

Representative examples of halogenated phosphate esters include 2-chloroethanol phosphate (C₆H₁₂Cl₂O₄P); 1-chloro-2-propanol phosphate [tris(1-chloro-2-propyl)phosphate] (C₉H₁₈Cl₃O₄P) (TCPP); 1,3-Dichloro-2-Propanol Phosphate (C₉H₁₅Cl₆O₄P) also called tris(1,3-dichloro-2-propyl)phosphate; tri(2-chloroethyl)phosphate; tri(2,2-dichloroisopropyl)phosphate; tri(2,3-dibromopropyl)phosphate; tri(1,3-dichloropropyl)phosphate; tetrakis(2-chloroethyl)ethylene diphosphate; bis(2-chloroethyl) 2-chloroethylphosphonate; diphosphates[2-chloroethyl diphosphate]; tetrakis(2-chloroethyl)ethylenediphosphate; tris-(2-chloroethyl)-phosphate, tris-(2-chloropropyl)phosphate, tris-(2,3-dibromopropyl)-phosphate, tris(1,3-dichloropropyl)phosphate tetrakis(2-chloroethyl-ethylene diphosphate and tetrakis(2-chloroethyl)ethyleneoxyethylenediphosphate. When used as a flame retardant, the halogenated phosphate ester will comprise 0.5 to 30 percent by weight of the final foam.

Dehydratable flame retardants, such as alkali silicates, zeolites or other hydrated phosphates, borosilicates or borates, alumina hydroxides, cyanuric acid derivatives, powdered melamine, graphites, mica, vermiculites, perlites, aluminohydrocalcite, hydromagnesite, thaumasite, wermlandite, Al₂O₃.3H₂O, may also be used.

The dehydratable flame retardant is generally added to the polyurethane dispersion in an amount of from 5 to 120 parts per 100 parts dispersion solids of the final Compound. Preferably the flame retardant is added in an amount from 10 to 100 parts per 100 parts dispersion solids of the final Compound. More preferably the flame retardant is added in an amount from 10 to 80 parts per 100 parts dispersion solids of the final Compound.

Examples of hand feelhand feel additives include organic silicon compounds. When present, the amount of hand feel additive is 0.01% to about 10% by weight of the total weight of the dispersion. Preferably the amount of hand feel additive is between about 0.1% to about 5% by weight. In another embodiment, it is less than 3% by weight.

Antioxidants are known in the art and include polymeric hindered phenol resins.

In an embodiment according to any of the preceding aspects and/or embodiment(s), the synthetic leathers and methods described herein further comprise at least one additive that is CaCO₃, SiO₂, wood fibers, TiO₂, or combinations thereof.

In another embodiment of any of the previously described aspects and/or embodiments, the mixture further comprises at least one additive that is a flame retardant, a pigment, a flowing additive, hand feel additive, antioxidant, anti-UV additive, or combinations thereof. Typically, these additives comprise 0.01 to 10% by weight of the solid content. More preferably, these additives comprise 0.1-8% by weight (still more preferably, 2-5%) of the solid content.

The leathers disclosed herein typically are comprised of 0.1-99% PUD based on the weight of the pre-dried mixture. Preferably, the leathers are comprised of 60-99% PUD based on the weight of the pre-dried mixture. Still more preferably, the leathers are comprised of 70-95% PUD based on the weight of the pre-dried mixture.

The leathers disclosed herein have improved peel strength relative to the leathers that do not contain latex, are not impregnated with a PU resin and/or where the fabric is not a needled cotton and polyester fiber hybrid. By improved peel strength is meant a peel strength that is at least 10% higher than a corresponding synthetic leather that does not include any latex. More preferably is it at least 20% higher. Still more preferably is it at least 25% higher or even 30% higher.

Also, as previously mentioned, disclosed herein is a method of making a synthetic leather, the method comprising:

frothing a mixture comprising PUD, at least one thickener, at least one surfactant and latex;
applying the frothed mixture to a fabric that is optionally impregnated with a PU resin, thereby forming a coated fabric;

adjusting the thickness of the frothed PUD on the fabric; and

subjecting the coated fabric to drying conditions.

As will be appreciated by one of skill in the art, there are many different methods that may be used to froth the mixture comprising PUD and latex. Suitable methods include stirring, bubbling or blowing a gas through the mixture, chemical reaction and shaking.

The mixture comprising PUD and latex may be applied to the fabric using methods well known in the art, such as the use of a doctor knife. The froth may be applied to the optionally impregnated fabric using, for example, a Labcoater type LTE-S (Werner Mathis AG, Concord, N.C.). The doctor knife could be positioned about 0.5-2.75 mm above the impregnated synthetic leather, or at any other desired height.

The methods require drying or otherwise treating/curing the coated fabric (i.e., the optionally impregnated fabric that is coated with the frothed mixture) so that the synthetic leather forms. Any method known in the art, such as using UV light, IR light and/or heat may be used. Generally, heating takes place as quickly as practicable to fix the desired cell structure. The curing temperature may be any temperature suitable so long as the desired cell structure is retained and none of the components of the synthetic leather are decomposed. The heating time is desirably as short as practicable. Typical heating times range between seconds up to 1 hour. Any suitable heating method or heating energy source may be used such as a convection oven, heating plates, infrared oven, microwave heating or combination thereof. Suitable drying conditions include subjecting the froth coated fabric to 1) a constant temperature until dry, 2) a temperature gradient wherein the temperature changes over time, or 3) a multistep drying regime where the temperature is held for a set amount of time and then changed to a different temperature, which is then held for a set amount of time (3, 4, 5, or more drying steps may also be used). The drying times for each step may be the same or different. Typical drying times are from a few seconds up to one hour. Typical drying temperatures are in the range of at least 50° C. and no more than 250° C. Preferably the temperature is at least about 75° C., more preferably at least about 90° C. In one embodiment, the temperature is 90-190° C. and most preferably at most 170° C. One example of a suitable drying protocol is to subject the froth covered, optionally impregnated fabric to a temperature of 80-105° C. for 4-10 minutes and then to a temperature of 165-175° C. for 3-10 minutes. During the drying process, the water evaporates and the polyolefin sets (which may include melting of at least some of the material coated onto the fabric) and thereby forms the final coating. The drying process should not cause decomposition of any of the synthetic leather components.

The methods of making the synthetic leathers disclosed herein use optionally impregnated fabrics, where the fabrics and PU resins are as previously disclosed. In one preferred embodiment, the fabric is impregnated with PU resin. In another preferred embodiment, the fabric is non-woven with short standing-needled-fibers and it is not impregnated with PU.

Preferably, the methods of making the synthetic leathers disclosed herein, wherein the PUD mixture further comprises additional additives as is known in the art and as described above. In one embodiment, the additive is CaCO₃, SiO₂, wood fibers, TiO₂, or combinations thereof, where the thickeners are as described above. The PUD mixture may further comprise at least one additive that is a flame retardant, a pigment, a flowing additive, hand feel additive, antioxidant, anti-UV additive, or combinations thereof, wherein all of the aforementioned additives are as defined above. In one embodiment, the PUD mixture comprises an additive from only one of the aforementioned list of additives. In another embodiment, the PUD mixture comprises additives from both of the aforementioned lists of additives, for example, CaCO₃ and an antioxidant.

In one embodiment, the synthetic leathers are made according to the methods disclosed herein.

Preferably, the leathers disclosed herein have a fine surface structure that has virtually no free-standing fiber ends on the surface.

If desired, the leathers disclosed herein may be embossed and/or dyed, using methods known in the art.

The leathers disclosed herein do not require the use of an adhesive to attach the poromeric PUD layer to the fabric.

An additional benefit of incorporating at least one latex into the PUD mixture (and ultimately, into the synthetic leather) is that lower cost synthetic leather is produced. Furthermore, the leathers disclosed herein may be cut or otherwise shaped for any desired purpose, such as shoe manufacturing.

### DEFINITIONS

An internally stabilized polyurethane dispersion is one that is stabilized through the incorporation of ionically or nonionically hydrophilic pendant groups within the polyurethane of the particles dispersed in the liquid medium. Examples of nonionic internally stabilized polyurethane dispersions are described by U.S. Pat. Nos. 3,905,929 and 3,920,598. Ionic internally stabilized polyurethane dispersions are well known and are described in col. 5, lines 4-68 and col. 6, lines 1 and 2 of U.S. Pat. No. 6,231,926. Typically, dihydroxyalkylcarboxylic acids such as described by U.S. Pat. No. 3,412,054 are used to make anionic internally stabilized polyurethane dispersions. A common monomer used to make an anionic internally stabilized polyurethane dispersion is dimethylolpropionic acid (DMPA).

An externally stabilized polyurethane dispersion is one that substantially fails to have an ionic or nonionic hydrophilic pendant groups and thus requires the addition of a surfactant to stabilize the polyurethane dispersion. Examples of externally stabilized polyurethane dispersions are described in U.S. Pat. Nos. 2,968,575; 5,539,021; 5,688,842 and 5,959,027.

### Examples

In all of the examples (below), “PUD” refers to SYNTEGRA 3000, which is a waterborne, MDI based polyurethane produced without the use of organic solvents that is made by The Dow Chemical Co. It is a white liquid that typically has a solids content of 53.0-56.0 wt % and a density of 1.05 g/cc at 25° C.

TABLE 1
Fabric type

| Type | Component | Impregnation |
|---|---|---|
| Fabric 1 | Needled cotton and polyester fiber | No |
| | hybrid woven fabric | |
| Fabric 2 | Needled cotton and polyester fiber | No |
| | hybrid woven fabric with much shorter | |
| | fibers on the surface | |
| Fabric 3 | Needled cotton and polyester fiber | Solvent PU |
| | hybrid woven fabric | impregnated |

Note:
Fabrics 3 was made from dried Fabric 1 after being impregnated in 18% PU DMF solution.

TABLE 2
Latex information

| | Latex 1 | Latex 2 | Latex 3 |
|---|---|---|---|
| Materials | SCL- 371 | ST-57 | DirtShield K-2 |
| Solid content/% | 36 | 35 | 50 |
| T_{g}° C. | 5.4 | 16-22 | 53 |

PRIMAL SCL-371 latex is a medium hardness, general purpose acrylic binder. It is an anionic, off-white to tan liquid containing 35-37% acrylic polymer solids, less than 500 ppm residual monomers, less than or equal to 0.2% aqua ammonia and 63.0-65.0% water. It is commercially available from the Dow Chemical Company.

PRIMAL ST-57 is a water-based acrylic emulsion. It is commercially available from the Dow Chemical Company.

DIRTSHIELD K-2 is a 100% acrylic polymer emulsion. It is a milky, white liquid and it is based on an all-acrylic backbone. It is commercially available from the Dow Chemical Company.

### Procedure of Poromeric Layer Preparation:

### Control Sample: PUD Based Poromeric Layer Preparation

A poromeric layer of the synthetic leather was made using frothing PUD. The frothing PUD dispersion had a solids content of 50-60 (more preferably 53-56) percent by weight with ammonium stearate (STANFAX 320, Para-chem), disodium octadecyl sulfosuccinimate (STANFAX 318, Para-chem), cocamidopropyl betaine (STANFAX 590, Para-chem) and acrylic acid copolymer thickener (ACUSOL 810A, Dow). The thickened PUD viscosity was controlled to 13000 cp to 28000 cp. The detail PUD formulations were in Table 3.

To make a synthetic leather having a poromeric layer, the fabric was attached to pin frame. The frothing PUD was frothed using a Model 2MT1A foam machine (E.T. OAKES Corp.) run at 1000 rpm. The wet froth density was about 0.50-0.85 g/cm3. The froth was applied to fixed fabric using a Labcoater type LTE-S (Werner Mathic AG). The doctor knife was positioned at 1.8-2.5 mm between the roller and knife (including resin and fabric). The frothed dispersion was dispersed and the doctor bladed to foam a coating of frothed PUD on the fabric. The coated fabric was then placed in an oven at 100° C. for 6-10 min, which was then heated to 170° C. in about 5 min to form the synthetic leather having a poromeric layer.

TABLE 3
Latex free PUD poromeric layer formulation

| Component | Control | Sample 1 | Sample 2 |
|---|---|---|---|
| Fabric type | Fabric 1 | Fabric 2 | Fabric 3 |
| PUD (Syntegra 3000) | 1000 g | 1200 g | 2000 g |
| Stanfax 320 | 40.0 g | 48.0 g | 80.0 |
| Stanfax 590 | 11.3 g | 13.5 g | 22.6 |
| Stanfax 318 | 13.1 g | 15.6 g | 26.2 |
| Acusol 810A | 60.0 g | 79.4 g | 133 |
| Viscosity/cp | 17900 | 23300 | 21200 |
| Foam density (g/cm³) | 0.748 g | 0.690 g | 0.772 |

### Samples 3-5: Latex Modified PUD Based Synthetic Leathers Having Improved Peel Strength

The peel strength improved PUD poromeric layer was made essentially using the process described above. The only difference was the use of the following formulations and fabrics in Table 4.

TABLE 4
Latex containing PUD poromeric layer formulations

| | Sample 3 | Sample 4 | Sample 5 |
|---|---|---|---|
| Materials | Weight (g) | Weight (g) | Weight (g) |
| Fabric type | Fabric 3 | Fabric 3 | Fabric 3 |
| PUD | 960 | 960 | 800 |
| Latex 1 | 240 | — | — |
| Latex 2 | — | 240 | — |
| Latex 3 | — | — | 200 |
| Stanfax 320 | 48.0 | 48.0 | 40.0 |
| Stanfax 590 | 13.6 | 13.6 | 11.3 |
| Stanfax 318 | 15.7 | 15.7 | 13.1 |
| Acusol 810A | 130 | 96 | 60 |
| Viscosity/cp | 27300 | 22500 | 20400 |
| Foam density/ | 0.719 | 0.763 | 0.788 |
| (g/cm³) | | | |

The volumes of Samples 3-5 weren't the same as in the Control, but the ratios were similar, except for the thickener (Acusol 810A).

### PUD Viscosity Measurement

Bulk viscosities of the thickened PUD before frothing were measured using a Brookfield viscometer with a 20 rpm #6 spindle.

### Peel Strength Test:

Peel strength tests were conducted according to GB/T 8949-2008 Chinese Standard. The synthetic leather was cut into two 15 cm×12 cm leather sheets. These two leather sheets were glued together by suitable adhesive leaving about 5 cm (in the length direction) trips where no adhesive was applied. The two pieces were allowed to press by 5 Kg steel plate, dry and cured over 24 hours. The bonded sheet was cut along the length direction into 3 pieces of samples with 15 cm×3 cm. These 3 samples were tested by Instron machine with speed of 200 cm/min.

TABLE 5
Peel strength of the synthetic leathers

| | | Sample | Sample | Sample | Sample | |
|---|---|---|---|---|---|---|
| | Control | 1 | 2 | 3 | 4 | Sample 5 |
| Latex | none | none | none | Latex 1 | Latex 2 | Latex 3 |
| Fabric Type | 1 | 2 | 3 | 3 | 3 | 3 |
| Peel strength | 28 | 46 | 45 | 90 | 75 | 52 |
| (N/(3 cm)) | | | | | | |

The above data illustrates the following. First, synthetic leathers made from fabrics having shorter standing fibers have improved peel strength relative to a fabric having longer fibers. Compare the peel strength of the Control (28N/3 cm, fabric having long fiber) to Sample 1 (46N/3 cm, fabric having shorter fibers).

Second synthetic leathers made from fabrics that were previously impregnated with PU also have improved peel strength. Compare the Control (28N/3 cm, fabric having long fiber) to Sample 3 (90 N/3 cm, which uses the fabric from the control sample, but the fabric was previously impregnated with 18% PU/DMF solution).

Third, adding latex to the PUD mixture increases the peel strength. Compare Sample 2 (which used fabric 3, but did not include any latex, and had a peel strength of 45 N/3 cm) to Samples 4, 5, and 6, (all of which used fabric 3, contained latex and had peel strength values of 90, 75, and 52, respectively). While the data shows adding latex to the PUD will increase peel strength, it also shows the improvement was dependent on the latex that was used (compare Samples 3, 4, 5).

It was also surprising found that the above described PUD/latex based synthetic leathers also have improved embossability, when compared to PUD based synthetic leathers that do not contain latex, provided the latex has a T_{g}≧50° C.

Thus, disclosed herein are methods of making poromeric leather having improved embossing characteristics, the methods comprising:

combining polyurethane dispersed in water (PUD) at least one latex, at least one surfactant and at least one thickener to form a mixture;

frothing the mixture;
applying the frothed mixture to a fabric that is optionally impregnated with a PU resin, thereby forming a coated fabric;

adjusting the thickness of the frothed PUD on the optionally impregnated, coated fabric; and

subjecting the coated fabric to drying conditions.

In a further embodiment, the resulting leathers may be embossed as described below, or as known in the embossing arts.

Preferably, the latex has a T_{g}>50° C. More preferably, it is greater than 60° C., 70° C., 80° C., 90° C., or 100° C. Without wishing to be bound by a theory, it is believed that the higher the T_{g} of the latex, the better the ability of the synthetic leather to maintain a pattern embossed onto it.

In a preferred embodiment, the synthetic leathers made according to the above method also have improved peel strength.

TABLE 6
Latex properties

| | Latex 1 | Latex 2 |
|---|---|---|
| Materials | DirtShield ™ K-2 | New material |
| Company | Dow | Not commercially |
| | | available |
| Tg/° C. (DSC) | 53 | 108 |
| Solid content % | 50 | 50 |
| Formulation | 100% Acrylate | Process and |
| | emulsion | formulation in Table 7 |

Note:
The latex 2 was made from follow formulation by latex synthesis process in Table 7.

TABLE 7
Latex 2 formulation and synthesis process

| | |
|---|---|
| Composition | 48% Styrene/49% Methyl methacrylate/ |
| | 2% Methacrylic acid/1% QM-1458 |
| | (a heteroalkyl methacrylate based adhesion |
| | promoter sold by The Dow Chemical Company) |
| Buffer | 0.3Na₂CO₃ |
| Surfactant | 1.15% A-19 (purchased from Stepan, sodium salt Linear |
| package | Alkylbenzene Sulfonate, 19% solution) |
| | (0.1 kettle/1.05 monomer emulsion) |
| Initiation | Ammonium persulfate (0.35 kettle/ |
| | 0.15 cofeed)/0.15% sodium bisulfate (cofeed) |
| Feed time | 120 min |
| Neutralizer | NH₄OH |

The PUD/Latex poromeric synthetic leather was made using the process as described for the “Control” sample in Table 3, but using the formulations described in Table 8 (below).

TABLE 8
PUD/Latex poromeric layer's formulation

| | Sample 6 | Sample 7 |
|---|---|---|
| Materials | Weight/g | Weight/g |
| PUD (Syntegra 3000) | 800 | 800 |
| Latex 1 | 200 | — |
| Latex 2 | — | 200 |
| Stanfax 320 | 40 | 40 |
| Stanfax 590 | 11.3 | 11.3 |
| Stanfax 318 | 13.1 | 13.1 |
| Acusol 810A | 60 | 60 |
| Viscosity/cp | 20400 | 20300 |
| Foam density/(g/cm³) | 0.788 | 0.620 |

### Procedure of Poromeric Layer Embossing:

The poromeric synthetic leather was placed in a 170° C. (or 190° C.) oven heated for 10 min., and then pressed (1-10 MPa) for 3 seconds in a cool press machine.

What is claimed is:

1. Synthetic leathers comprising a fabric that is optionally impregnated with a polymer resin, wherein the fabric is in contact with a polymeric layer that was made from a frothed mixture comprising a polyurethane dispersion in water (PUD), at least one surfactant, at least one thickener, and at least one latex.

2. Synthetic leathers according to claim 1, wherein the PUD is dispersed in a solvent that is selected from the group consisting of water.

3. Leathers according to claim 1, wherein at least one surfactant is ammonium stearate, disodium octadecyl sulfosuccinimate or cocamidopropyl betaine.

4. Leathers according to claim 1, wherein the latex has a T_{g}≧50° C.

5. Leathers according to claim 1, wherein the latex has a T_{g}≦50° C.

6. Leathers according to claim 1, wherein the fabric is impregnated with a polymer resin.

7. Leathers according to claim 1, wherein the latex comprises at least one of the following: butyl acrylate, ethyl acrylate, 2-ethyl hexyl acrylate, glacial acrylic acid, methyl acrylate, methyl methacrylate, methyl crotonate, styrene, vinyls, butadiene, or acrylonitrile.

8. Leathers according to claim 1, wherein the mixture further comprises at least one additive that is a filler that is wood fibers, CaCO₃, SiO₂, or TiO₂, a flame retardant, a pigment, a flowing additive, hand feel additive, antioxidant, anti-UV additive, antistatic agent, antimicrobial agent, or combinations thereof.

9. Leathers according to claim 1, having improved embossability.

10. Leathers according to claim 1, having improved peel strength.

11. Leathers according to claim 1, wherein the mixture comprises at least two surfactants.

12. Methods of making a synthetic leather, the method comprising:
frothing a mixture comprising PUD, at least one surfactant, at least one thickener and at least one latex;
applying the frothed mixture to a fabric that is optionally impregnated with a PU resin, thereby forming a coated fabric;
adjusting the thickness of the frothed PUD on the fabric; and
heating the coated fabric sufficiently to dry and cure the PUD.

13. Methods according to claim 12, wherein at least surfactant is ammonium stearate.

14. Methods according to claim 12, wherein the latex has a T_{g}≧50° C.

15. Methods according to claim 12, wherein the latex has a T_{g}≦50° C.

16. Methods according to claim 12, wherein the fabric is impregnated with a polymer resin.

17. Methods according to claim 12, wherein the latex comprises at least one of the following: butyl acrylate, ethyl acrylate, 2-ethyl hexyl acrylate, glacial acrylic acid or methyl acrylate, methyl methacrylate, methyl crotonate, styrene, vinyls, butadiene, or acrylonitrile.

18. Methods according to claim 12, wherein the mixture further comprises at least one additive that is a filler that is wood fibers, CaCO₃, SiO₂, or TiO₂, a flame retardant, a pigment, a flowing additive, hand feel additive, antioxidant, anti-UV additive, antistatic agent, antimicrobial agent, or combinations thereof.

19. Synthetic leathers made according to the methods of claim 12.
